(19) United States
(12) Patent Application Publication
(10) Pub. No.: US 2006/0019608 A1
(43) Pub. Date: Jan. 26, 2006

(54) Communications device, mobile terminal

(75) Inventors: Yusuke Furuumi, Yokosuka (JP); Masaaki Suzuki, Yokohama (JP); Takurou Nishikawa, Yokohama (JP)

Correspondence Address: SWIDLER BERLIN LLP, 3000 K STREET, NW, BOX IP, WASHINGTON, DC, 20007, US

(73) Assignee: Fujitsu Limited

(21) Appl. No.: 11/078,328

(22) Filed: Mar. 14, 2005

(30) Foreign Application Priority Data
Jul. 22, 2004 (JP) 2004-214349

(51) Int. Cl. H04B 17/00

(52) U.S. Cl. 455/67.15

(57) ABSTRACT

An HSDPA-compatible mobile terminal comprises a first measurement unit that measures the CPICH reception quality, a second measurement unit that measures the HS-PDSCH reception quality, a control unit that exerts control, depending on the reception environment, to either generate the CQI information using, primarily, the measurement results in the first measurement unit, or to generate the CQI in the first measurement unit, or to generate the CQI information using, primarily, the measurement results in the second measurement unit, and a transmission unit for transmitting said CQI information to a ground base station.

### CROSS REFERENCE TO RELATED APPLICATION

This application is related to and claims priority to Japanese Application No. 2004-214349 filed Jul. 22, 2004 in the Japanese Patent Office, the contents of which are incorporated by reference herein.

### BACKGROUND OF THE INVENTION

1. Field of the Invention

The present invention relates to communications devices, and relates to mobile terminals that are used in mobile wireless communications systems that employ, for example, the W-CDMA (UMTS) communications method.

2. Description of the Related Art

At present, in the 3rd Generation Partnership Project (3GPP), efforts are underway to standardize the W-CDMA (UMTS) method as one method for third-generation mobile communications systems. Furthermore, one of the standardization themes is the standardization of an High-speed Downlink Packet Access (HSDPA) that provides a maximum downlink transfer speed of approximately 14 Mbps.

HSDPA uses an adaptive modulation and coding method (AMC) to adaptively switch between, for example, a QPSK modulation scheme and a 16 QAM scheme, depending on the wireless environment between the base station and the mobile terminal.

Furthermore, HSDPA employs the Hybrid Automatic Repeat reQuest (H-ARQ) scheme. In H-ARQ, a retransmission request to the applicable base station is made when the mobile terminal detects an error in the data received from the base station. The base station, after it has received the retransmission request, retransmits the data, so the mobile terminal performs error correction decoding using both the data that has been received already and the data received after the retransmission. In this way, in H-ARQ, the data that has already been received can be used effectively, even when there is an error, increasing the gain of the error correction decoding, and reducing the number of resend repetitions.

The primary wireless channels used in HSDPA are the High Speed-Shared Control Channel (HS-SCCH), the High Speed-Physical Downlink Shared Channel (HS-PDSCH), and the High Speed-Dedicated Physical Control Channel (HS-DPCCH).

In HS-SCCH and HS-PDSCH, both use the shared channel approach in the downlink direction (or in other words, in downlinks from the base station to the mobile terminal), where HS-SCCH is a control channel that transmits a variety of parameters relating to the data being transmitted via HS-PDSCH. These various parameters include, for example, modulation-type data that indicates the type of modulation method that will be used when transmitting data using the HS-PDSCH, the number of spreading codes that have been allocated (the number of codes) for the transmission of the HS-PDSCH, and the rate matching pattern performed for the transmission data of the HS-PDSCH.

On the other hand, HS-DPCCH is a dedicated control channel for uplinks (or in other words, uplinks from the mobile terminal to the base station), used when the mobile terminal transmits to the base station the ACK signal or the NACK signal, depending on whether the data received via the HS-PDSCH is received or not. Note that when the mobile terminal fails to receive the data (such as when there is a CRC error in the received data), the NACK signal is transmitted from the mobile terminal, and the base station performs retransmission control.

Otherwise, HS-DPCCH is used for a mobile terminal that has measured the reception quality (for example, SIR) of signals received from the base station in order to transmit the results of the measurements to the base station as Channel Quality Indicator (CQI) information. The base station determines whether the wireless environment in the downlink direction is good or not good, and if good, switches to a modulation method that can support high speed data transmissions, but, conversely, if not good, switches to a modulation method that can transmit data more slowly. (In other words, adaptive modulation is performed.)

Channel Structure

The channel structure in HSDPA will be explained next.

FIG. 1 shows the channel structure in HSDPA. Note that W-CDMA employs a code-division multiplexing method, so each channel is separated by its

First, a simple explanation will be made of the channels that have not been code.

Common Pilot Channel (CPICH) and Primary Common Control Physical (P-CCPCH) are each shared channels in the downlink direction.

CPICH is a channel for sending a so-called pilot signal. This channel is used for a channel estimation at the mobile terminal, and used as a timing reference for another downlink physical channel within the cell, and used for performing a cell search. Each cell has a P-CCPCH, which channel is used for sending broadcast information.

Next, FIG. 1 will be used to explain the channel timing relationships.

As in the figure, each channel comprises one frame (10 ms), comprising 15 slots, where each slot is the equivalent of 2560 chips. As described above, because CPICH is used as the reference for other channels, the beginning of the P-CCPCH and the HS-SCCH frames match the beginning of the CPICH frame. Here the beginning of the HS-PDSCH frame is delayed for 2 slots relative to HS-SCCH, or the like, but because the modulation-type information is received by the mobile terminal via HS-SCCH, it is possible to demodulate the HS-PDSCH using the demodulation method that corresponds to the modulation type received. Furthermore, the HS-SCCH and HS-PDSCH are comprised of a single subframe of 3 slots.

HS-DPCCH is an uplink channel, where the first slot is used for sending from the mobile station to the base station the ACK/NACK signals that are response signals for confirming reception, after approximately 7.5 slots from the reception of the HS-PDSCH. Furthermore, the second and third slots are used for sending feedback to the base station on a regular schedule regarding the CQI information for adaptive modulation control. Here the CQI information that is transmitted is selected based on the reception environment (for example, based on the CPICH SIR measurement results) in the interval from 4 slots prior to the sending of the CQI information to 1 slot prior to the sending of the CQI information.

FIG. 2 shows the CQI table when the CPICH Signal-to-Interference Ratio (SIR) is used.

As shown in the figure, the table defines the correspondence of the CPICH-SIR with the modulation type, the number of codes, and the number of bits for the Transport Block Size (TBS) for each of the CQI data 1 through 30.

Here the TBS number of bits is the number of bits that are transmitted in a single subframe, the number of codes is the number of spreading codes used in HS-PDSCH transmission, and the modulation type indicates the use of either QPSK or 16-QAM.

As is clear from the figure, the better the SIR (i.e., the higher the SIR) in CPICH, the bigger the value for the CQI. The bigger the CQI, the larger the corresponding TBS number of bits and the number of spreading codes, and the modulation method also switches to the QAM a modulation method, and so, of course, the better the SIR, the faster the transmission speed.

The table in the figure is stored, for example, in a memory possessed by the mobile terminal. Note that this table can be created based on actual measurements of the received SIRs of the CPICH under a variety of transmission conditions in condition that a specific error rate is maintained.

As already explained, the mobile terminal measures the SIR of the CPICH in a reception environment measurement interval and refers a table in memory, and selects a CQI corresponding to the measured SIR, and transmits selected CQI to the base station.

The base station performs the adaptive modulation control according to the received CQI information described above, and is able to achieve transmission control taking into consideration the reception environment of the CPICH at the mobile terminal.

The above was a simple explanation of the HSDPA channel structure.

The items pertaining to the HSDPA, described above, are disclosed in, for example, the 3rd Generation Partnership Project: Technical Specification Group Radio Access Networks; Multiplexing and Channel Coding (FDD), 3G TS 25. 212.

Given the prior art described above, the mobile terminal, which acts as the communications device, measures the reception environment, and the results are reported to the base station, which acts as the transmission device, and adaptive modulation control is performed in the transmission device according to the reception environment.

However, the measurement of the mobile terminal is on a channel different from the channel adopting adaptive modulation.

Conventionally, it is ideal to specify the CQI information according to the reception quality of the channel on which the adaptive modulation control is performed itself (HS-PDSCH), but the HS-PDSCH cannot be used easily.

That is to say, the signals transmitted on the HS-PDSCH are not known in advance; when, for example, the QPSK method is selected, the received signal does not necessarily make it possible to evaluate correctly which of the 4 signal points to use, and, ultimately, it is not possible to accurately measure the reception SIR. In particular, when the 16 QAM method is selected, there are 16 signal points—four times as many—making the measurement of the reception SIR difficult.

Given this, in the prior art, the reception SIR of the CPICH, a known channel that is different from the channel adopting the adaptive modulation control is to be performed, is accurately measured and used to select the CQI.

However, as already explained, the SIR of the CPICH is a different channel from the HS-PDSCH, which is a channel on which the adaptive modulation control is to be performed (a channel wherein the spreading and transmission use a different spreading code), and thus it cannot be said that the reception environment is accurately reflected in the HS-PDSCH, so the adaptive modulation control does not operate ideally, and there is a loss of efficiency.

Consequently, one object of the present invention is to track the reception environment on the channel on which the adaptive modulation control is to be performed, allowing ideal operation.

Note that the effects derived from the various structures that are optimized in order to implement the inventions described below are not limited to the object described above, but rather, being able to produce effects that cannot be obtained through conventional technologies can be listed as one of the objects of the present invention.

### SUMMARY OF THE INVENTION

The present invention uses an HSDPA-compatible mobile terminal, comprising a first measurement unit that measures the CPICH reception quality, a second measurement unit that measures the HS-PDSCH reception quality, a control unit that controls, depending on the reception environment, whether to produce CQI information using the measurement results of, primarily, said first measurement unit or whether to produce CQI information using the measurement results of, primarily, said second measurement unit, and a transmitter unit that transmits said CQI information to a radio base station.

The present invention uses a mobile terminal, wherein said control unit uses, primarily, the measurement results from said second measurement unit when the reception environment is favorable, and uses, primarily, the measurement results from said first measurement unit when the reception environment is not favorable.

The present invention uses a mobile terminal wherein said reception environment is estimated with the measurement results in said first measurement unit.

The present invention uses a mobile terminal wherein said control unit either provides control to switch to either generating CQI information using the measurement results in said first measurement unit, or generating CQI information using the measurement results in said second measurement unit, depending on the reception environment, or provides control to switch, depending on the reception environment, the weighting ratio for the measurement results in the first measurement unit and the measurement results in the second measurement unit from having the measurement results in the first measurement unit take priority, to having the measurement results in the second measurement unit take priority.

The present invention uses a mobile terminal, further comprising a memory unit that stores primary memory data that stores the correlation between the CQI information and the measurement results in said first measurement unit, and secondary memory data that stores the correlation between the CQI information and the measurement results in said second measurement unit, and wherein when performing said switching, the memory information used in generating the CQI information is switched as well.

The present invention uses a mobile terminal further comprising a memory unit that stores a correlation relationship between the measured quality values and the CQI information, and a compensation unit that corrects the measurement results in said first measurement unit or the measurement results in said second measurement unit, wherein said control unit generates said CQI information by obtaining, from said memory units, the CQI information that corresponds to the measurement results corrected by said compensation unit.

The present invention uses a communications device that not only receives signals known in advance, but also receives signals subjected to adaptive modulation control, comprising a first measurement unit that measures the reception quality of said known signals, a second measurement unit that measures the reception quality of said signal that has been subjected to adaptive modulation control, a control unit that controls, depending on the reception environment, whether to use, primarily, the measurement results in said first measurement unit, or to use, primarily, the measurement results in said second measurement unit, when producing the parameter information that is used in said adaptive modulation control, and a transmitting part that transmits said parameter information to the equipment that performs said adaptive modulation.

The present invention uses an HSDPA-compatible mobile terminal that measures the CPICH reception quality, that generates CQI information based on said reception quality by a control unit, and that transmits said CQI information from a transmission unit, comprising a measurement unit that measures the HS-PDSCH reception quality, wherein said control unit uses the measurement results in said measurement unit according to the reception environment when producing said CQI information.

The present invention uses a communications device that not only receives known signals but also, for transmission equipment that performs adaptive modulation control, transmits parameter information that is used in said adaptive modulation control, based on the reception quality of said known signal, comprising a measurement unit that measures the reception quality of the signal that was subjected adaptive modulation control and transmitted from said transmission equipment, and a control part that performs control so that the reception quality measured by said measurement unit is used, depending on the reception environment, when generating said parameter information.

Given the communications device according to the present invention, it is possible to perform adaptive modulation control ideally.

### BRIEF DESCRIPTION OF THE DRAWINGS

FIG. 1 shows the channel structure in HSDPA.

FIG. 2 shows an example of a CQI table.

FIG. 3 shows a communications device (mobile terminal) according to the present invention.

FIG. 4 shows an SIR measurement in the HS-PDSCH reception processor according to the present invention.

### DETAILED DESCRIPTION OF THE PREFERRED EMBODIMENTS

Forms of embodiment of the present invention will be explained, referencing the figures below.

Explanation of a First Form of Embodiment

In the present form of embodiment, a known signal (CPICH) is received, and a signal subject to adaptive modulation control (HS-PDSCH) is received, so the adaptive modulation control can be optimized by switching between either controlling focusing on the reception quality of the known signal, or controlling focusing on the reception quality of the signal that is subject to adaptive modulation control.

Communications Device

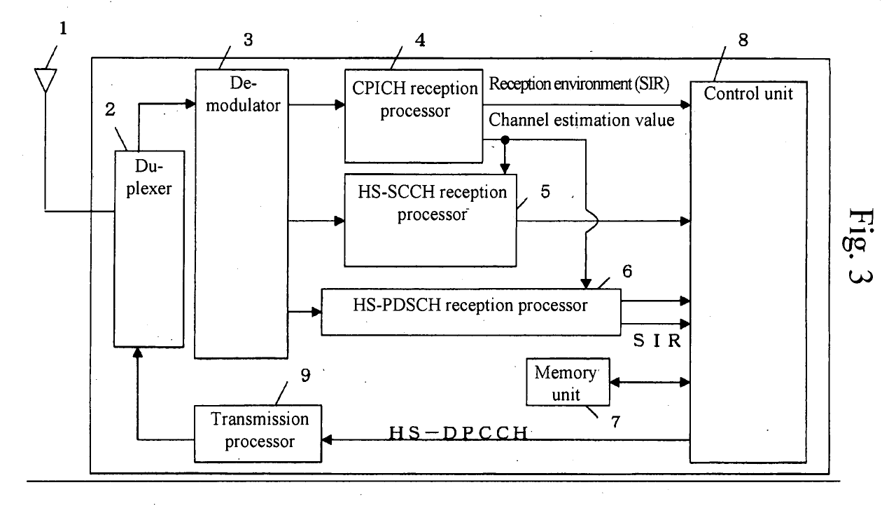

The communications device according to the present invention will be explained next, using FIG. 3.

FIG. 3 shows a communications device according to the present invention. As an example of a communications device, a mobile terminal that is used in a mobile communications system compatible with W-CDMA (UMTS), which uses HSDPA, will be described. Of course, the present invention can also be applied to communications device used in other mobile communications systems.

In the figure, 1 is an antenna, 2 is a duplexer, 3 is a demodulator, 4 is a CPICH reception processor, 5 is an HS-SCCH reception processor, 6 is an HS-PDSCH reception processor, 7 is a memory unit, 8 is a control unit, and 9 is a transmission processor.

The mobile terminal receives downlink channels (for example, CPICH, P-CCPCH, HS-SCCH, HS-PDSCH, etc.) through an antenna 1, and applies them to a demodulator 3 through a duplexer 2. The demodulator 3 performs reception processing for the received signal such as orthogonal (wave) detection, and the like, and applies the demodulated signal to the CPICH reception processor 4, the HS-SCCH reception processor 5, and the HS-PDSCH reception processor 6.

The CPICH reception processor 4 measures the reception environment used for specifying the CQI information as the parameter that is used in the adaptive modulation control in the base station. For example, the SIR of the CPICH downlink signal is measured. Additionally, the CPICH reception processor 4 uses the fact that the CPICH that is received is a known signal in order to calculate channel estimation values for compensating for phase rotation, and attenuation, and the like for the signal in a transmission path (i.e., to perform channel compensation) and applies the results to the HS-SCCH reception processor 5 and the HS-PDSCH reception processor 6. Obtaining the channel estimation values through evaluating, in the phase plane, how much the received signal has shifted relative to a known signal is a well-known technique.

Note that the measurement of the reception environment is done by measuring, at regular intervals between 4 slots and 1 slot previous to the slot wherein, for example, the CQI data is sent. Although a variety of different measurement periods can be considered, performing one measurement in 20 ms, sending the same measurement results repetitively in the first through fourth subframes, not sending in the remaining six subframes (fifth, sixth, seventh, eighth ninth and tenth subframe), and then beginning to measure once in the next radio frame, and then, similarly, sending in specific subframes is a possibility.

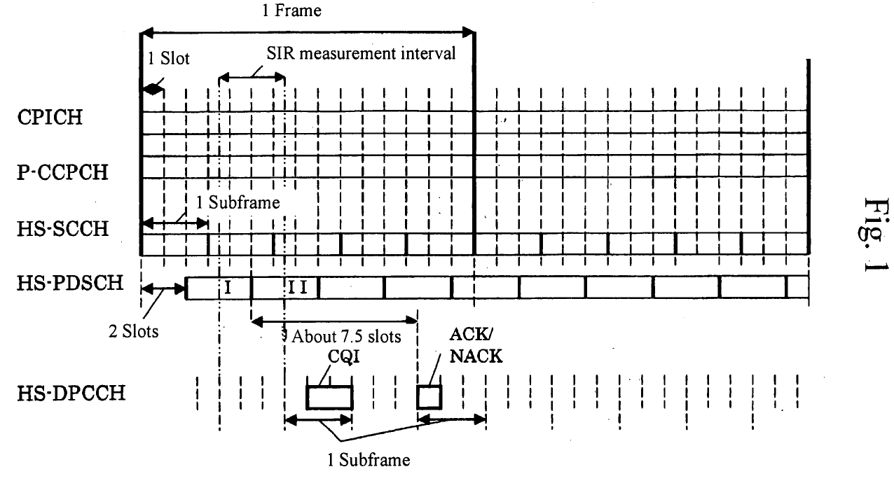

HS-SCCH reception processor 5 is a reception processor for receiving a signal that is transmitted via the HS-SCCH, shown in FIG. 1. HS-SCCH reception processor 5 receives each of the first slots of HS-SCCH and performs a despreading process and a decoding process with the channel estimation value to determine whether or not there is a message to the mobile terminal.

The first slot is a slot that transmits a signal wherein the Channelization Code Set Information (Xccs) and Modulation Scheme Information (Xms) are coded by a convolution coding, multiplied with the User Equipment Identity (Xue) and transmitted, making it possible for the mobile terminal to determine whether or not there is a message for the mobile terminal through performing reverse-consolation processes using the local Xue and decoding process. If it is determined that a message is for the mobile terminal, then the mobile terminal perform not only reception for the remaining HS-SCCH slots, but also an attempt to receive the HS-PDSCH signal that is transmitted with a 2-slot delay.

Here, when the HS-PDSCH reception is performed, demodulation is performed using the set of despreading codes specified by Xccs, and a demodulation method corresponding to the modulation method specified by Xms. Note that the Transport Block Size information (Xtbs), Hybrid ARQ Process information (Xhap), Redundancy and constellation Version (Xrv), and New Data indicator (Xnd) are included in the second slot and beyond in HS-SCCH. The meaning and roles played by these data are well-known, and thus explanations thereof are omitted.

The HS-PDSCH reception processor 6 performs the reception processing when the HS-SCCH processor 5 detects a message to the mobile terminal, and outputs to the control unit 8 the results of demodulation and decoding. As has already been explained, the information that is required for performing the demodulation processes, and the like, is obtained from the received HS-SCCH. The control unit 8 is able to confirm whether or not there actually was a transmission to the mobile terminal through the HS-PDSCH, from the results of the decoding (confirming that, for example, there was no CRC error).

Furthermore, the HS-PDSCH reception processor 6 also performs the SIR measurement when there is a message to the mobile terminal. Note that this measurement may instead be performed only when it has been determined that the reception environment is favorable.

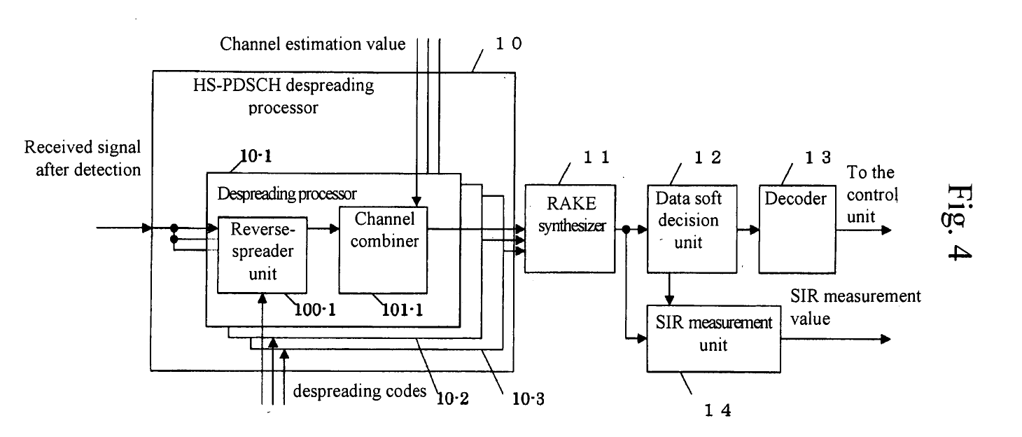

Here, FIG. 4 will be used to provide a brief explanation of the SIR measurement process in the HS-PDSCH reception processor 6.

In FIG. 4, 10 indicates the HS-PDSCH despreading processor. Note that the HS-PDSCH despreading processor 10 should be equipped with a quantity matching the number of codes that will perform despread processing.

The despreading processor 10 is equipped with multiple despreading processors 10-1 through 10-3 (where, in this example embodiment, there are 3 despreading processors), to handle multiple paths, where each of the despreading processors comprises a despreading part 100-1 and a channel compensator 101-1.

A RAKE combiner 11 performs maximum-ratio combine for the signals after the despreading from the despreading processors. 12 indicates a data soft-decision unit, and 13 indicates a decoder that performs decoding processes such as turbo decoding on the input data.

The operations will be described briefly next.

The input reception signal is input in parallel into the despreading processors 10-1 through 10-3, and input into the respective despreading units 100 (−1 through −3).

The despreading units 100 use the despreading codes applied by the despreading code generator (not shown) to perform despreading processes on the reception signals.

Here the despreading units 100-1 through 100-3 perform despreading processing for the respective paths, and each have mutually differing despreading timing.

In the despreading units 100, the despread reception signals are input into the channel compensators 101 (−1 through −3), where channel compensation processes, which should compensate for phase rotation, attenuation, and the like, in the transmission path, are performed.

As explained above, the channel estimation value from the CPICH reception processor 4 is input into the HS-PDSCH reception processor 6, where this channel estimation value can perform the channel compensation through multiplying the reception signal with the channel compensation coefficients.

The signal received via the multi-path, after despreading processing in the despreading processor 10-1, as described above, is input into the RAKE combiner 11, where maximum-ratio combine is performed, and results are output.

The RAKE-combined signal is next subjected to decisions regarding the corresponding signal points in the data soft-decision unit 12, and likelihood information that indicates how closely the signal points are approximated is output.

The SIR measurement unit 14 calculates the SIR based on the deviation from the signal points, judged by the data soft-decision unit for the reception unit after RAKE combine, and outputs the calculated SIR to the control unit 8.

Decoder 13 performs a decoding process, such as turbo decoding, or the like, on the input data, and after error correction, the data is output to the control unit 8.

As described above, the HS-PDSCH decoding and SIR measurement are performed in the HS-PDSCH processor 6, and the results thereof are input into the control unit 8.

Let us again return to the explanation of FIG. 3.

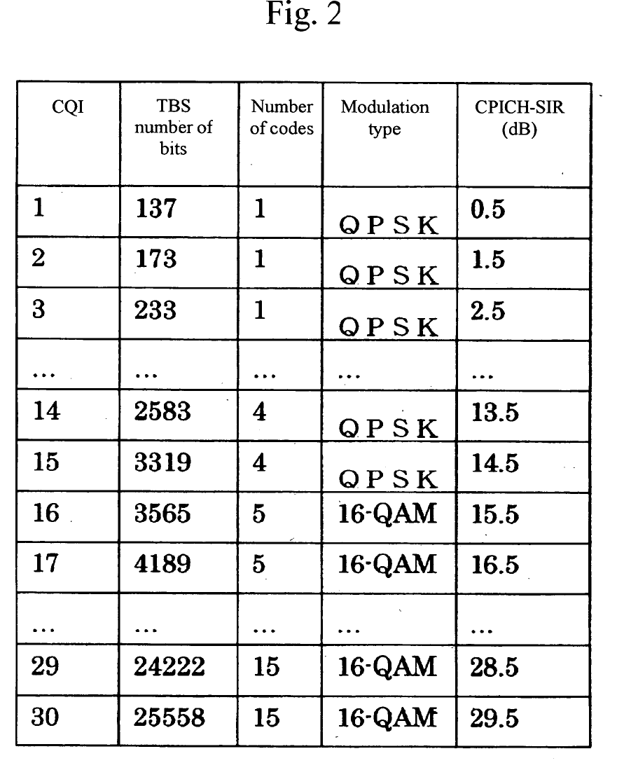

The memory unit 7 stores, in addition to the CQI (Table 1), shown in FIG. 2, the CQI information corresponding to each SIR of the HS-PDSCH as a CQI table (Table 2).

The control unit 8 not only controls the operations of the various parts, but receives, from the CPICH reception processor 4, the reception SIR, receives reception data from the HS-SCCH reception processor, and receives decoding data and reception SIR information from the HS-PDSCH reception processor, and processes the same.

Furthermore, the control unit 8 references the information that is stored in the memory unit 7 to produce the CQI information, which is applied to the transmission processor 9, and produces the ACK signal or NACK signal depending on the results of the CRC check in the HS-PDSCH and similarly applies to the transmission processor 9.

The transmission processor 9 transmits, from the control unit 8, the CQI information and the ACK or NACK signal in a specific slot in the HS-DPCCH.

The operations of various units shown in FIG. 3 were explained above. Note that the base station not only performs transmission in a transmission (modulated) method based on the CQI information that was received through the HS-DPCCH, but also transmits the next new data when an ACK signal is received, or when the NACK signal is received, or when no ACK signal is received within a specific amount of time, performs a retransmission of the transmission data.

CQI Information Generation Method 1

Next, the method of generating the CQI information as the parameters transmitted to the base station by the mobile terminal, will be explained in detail.

In this example, the processor unit 8 determines, based on the CPICH SIR measurement value from the CPICH reception processor unit 4, whether the reception environment is favorable or unfavorable, and if the reception environment is favorable, the HS-PDSCH reception quality is used.

As explained above, the signal received through the HS-PDSCH is not a known signal, and so generally the reception quality (SIR) cannot be measured actually through a signal point error judgment.

However, when the reception environment is favorable, the decision accuracy for the signal points is heightened, and thus the measurement precision of the quality (SIR) of the HS-PDSCH is enhanced, and thus it is possible to improve the reliability through the indirect use of the reception quality of the CPICH.

In particular, the better the reception environment, the more important it is to perform high-speed transmission by performing the adaptive modulation control accurately, and so this is convenient.

Given this, in the CQI information generation method 1, when the SIR measurement value is greater than a specific reference, the CQI information is generated using the CQI table (Table 2) for the HS-PDSCH that is recorded in the memory unit 7, based on the SIR measurement value from the HS-PDSCH reception processor 6, and said CQI data is applied to the transmission processor 9.

Note that it is possible to either measure the reception SIR for the HS-PDSCH with a specific error rate, or possible to generate said reception SIR through simulations for making this Table 2 in the various transmission conditions. In particular it is preferable to store HS-PDSCH SIR in condition that high speed data is transmitted with the specific error rate among the various transmission conditions as Table 2 in memory. Of course, under all of the transmission conditions the data for the table can be measured in advance.

On the other hand, when the SIR measured by the CPICH reception processor 4 are below a specific standard, the control unit 8 generates the CQI information using the CQI table (Table 1) that is stored in the memory unit 7, based on the SIR measured by the CPICH reception processor 4 and the control unit 8 applies the result (the generated CQI information) to the transmission processor 9.

In this way, if the reception environment is favorable, then the CQI information is generated based on the HS-PDSCH reception quality (SIR), but if the reception environment is not favorable, then the CQI information is generated based on the CPICH reception quality (SIR), thus making it possible to use effectively the HS-PDSCH reception SIR.

Note that, using a different expression, when the reception environment is favorable, the measurement results of the HS-PDSCH reception SIR are used, making it possible to use the HS-PDSCH reception SIR effectively.

CQI Information Generation Process 2 (Shared Table)

Note that in above example, 2 CQI tables were prepared, but a signal table may be used instead. In other words, of these CQI tables, the CQI can be associated with the HS-PDSCH reception SIR for the side on which the reception environment is favorable (the side wherein the CQI is large), and the CQI can be associated with the CPICH reception SIR on the side wherein the reception environment is not favorable (the side wherein the CQI is small).

By doing this, the control unit 8 may switch between using the CQI from the CPICH and using the CQI from the HS-PDSCH using the SIR as the key information for referring the single table depending on the reception environment. At this time, only a single SIR value corresponding to the CQIs that have been obtained, can be used, so all of the SIR values must be either those from the CPICH or those from the HS-PDSCH.

By switching the SIR as the key information for referring the table, it is possible to change the table reference part as well, making it possible to perform the adaptive modulation control effectively.

CQI Information Generation Method 3 (Weighted Composite)

Furthermore, while the SIR used for the CQI selection can simply be switched between that of the CPICH and that of the HS-PDSCH, as a more sophisticated concept, the reception SIR of the CPICH and the reception SIR of the HS-PDSCH can form a weighted compound.

In other words, when the reception environment is favorable (for example, when the reception SIR for the CPICH is high), then the weighting on the HS-PDSCH would be greater than the weighting on the CPICH, but when the reception environment is not favorable (for example, when the reception SIR for the CPICH is low), then the weighting on the HS-PDSCH would be less than the weighting on the CPICH.

By doing this, the CQI information can be selected according to, primarily, the reception quality of the HS-PDSCH when the reception environment is favorable, but, when the reception environment is not favorable, the CQI information can be selected according to, primarily, the reception quality of the CPICH. Note that the table used for this can be the table shown in FIG. 2.

Note that in the example embodiment described above the SIR value can be corrected, as necessary, through referring the CQI table.

Reception Environment—Other Decision Method 1

In the example above, the decision as to whether or not the reception environment is favorable or unfavorable was made based on the reception SIR of the CPICH, but changes can also be made other parameters. For example, the reception quality of other channels, such as the HS-SCCH or the HS-PDSCH, can be used. Note that, in this case, the decision as to whether or not there is a transmission to the mobile terminal in the HS-PDSCH is made by the process described above in the HS-SCCH reception processor 5, and if the transmission to the mobile terminal is informed, then the reception quality (SIR) of the HS-PDSCH is measured, and if the value is high, then the value can be used in generating the CQI information. In such a case, it is desirable to use the Table 2.

Reception Environment—Other Decision Method 2

Furthermore, it is also possible to judge whether the reception environment is favorable or unfavorable based on information received via the HS-SCCH.

In other words, it is possible to judge whether or not the reception environment is favorable or unfavorable through detecting, in the HS-SCCH reception process, a notification that high-speed transmission are taking place to the mobile terminal.

For example, any of the following can be used: (1) Channelization Codes Set Information (Xccs): information that specifies the assigned spreading code set, the number of spreading codes, etc. (2) Modulation Scheme Information (Xms): information that specifies the modulation scheme, or (3) Transport Box Size Information (Xtbs): information that specifies the transport box size.

From (1), the reception environment can be judged to be favorable when the assignment of more than a specific number of spreading codes has been detected, or, from (2), the reception environment can be judged to be favorable when it has been detected that a 16 QAM has been specified, or, from (3), the reception environment can be judged to be favorable when the indicating transport block size is more than a specific transport box size (more than a specific number of bits).

In particular, when it comes to (1) and (2), it is possible to use these methods quickly, because this information is sent rapidly in the first slot.

Although fundamental explanations were made regarding the CQI information generation, above, when it comes to the constant (periodical) transmission of the CPICH, it is useful to consider the fact that the HS-PDSCH is not always (periodical) transmitted to the mobile terminal at all times.

As is shown in FIG. 1, it is possible to measure the CPICH on a regular basis with the SIR measurement period when the CQI should be sent at regular intervals; however, it is possible with HS-PDSCH that this information is not transmitted to the mobile terminal (transmitted to another mobile terminal).

Given this, when it comes to the SIR of the HS-PDSCH, the control unit 8 may store in memory SIR's that have been measured when there have been transmissions to the mobile terminal, prior to the CQI transmission, and use that stored information as the reception SIR of the HS-PDSCH to perform the processes described above.

Note that changes in the propagation environment when using a reception SIR for which too much time has elapsed may cause the adaptive modulation control to be incorrect, and thus SIR values for which more than a specific amount of time has elapsed should not be used, but rather it should be defined that there are no measured values for the received SIR of the HS-PDSCH, and the control unit 8 should generate the CQI information based on the received SIR of the CPICH.

The received SIR for the HS-PDSCH considered to have the highest reliability is the SIR that was measured in the subframe shown by the I in FIG. 1, wherein a subframe can be received completely prior to the timing of the transmission of the CQI in FIG. 1; however, in cases wherein there is a mismatch between the measurement timing, such as for the CPICH, and the subframe timing is tolerable, it is also possible to use the same measurement timing as the CPICH measurement timing.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. An HSDPA-compatible mobile terminal, comprising:
a first measurement unit operable to measure CPICH reception quality;
a second measurement unit that operable to measure HS-PDSCH reception quality;
a control unit operable to control, based on the reception environment, whether to produce CQI information using measurement results of, primarily, said first measurement unit, or whether to produce CQI information using measurement results of, primarily, said second measurement unit; and
a transmitter unit operable to transmit said CQI information to a radio base station.

2. The mobile terminal according to claim 1, wherein:
said control unit is further operable to use, primarily, the measurement results from said second measurement unit when the reception environment is favorable, and to use, primarily, the measurement results from said first measurement unit when the reception environment is not favorable.

3. The mobile terminal according to claim 1, wherein said reception environment is estimated with the measurement results in said first measurement unit.

4. The mobile terminal according to claim 1, wherein:
said control unit is further operable to either:
provide control to switch to generating CQI information using the measurement results in said first measurement unit, or provide control to switch to generating CQI information using the measurement results in said second measurement unit, depending on the reception environment; or
provide control to switch, depending on the reception environment, a weighting ratio for the measurement results in the first measurement unit and the measurement results in the second measurement unit from having the measurement results in the first measurement unit take priority, to having the measurement results in the second measurement unit take priority.

5. The mobile terminal according to claim 4, further comprising:
a memory unit operable to store:
primary memory data including a correlation between the CQI information and the measurement results in said first measurement unit, and
secondary memory data including a correlation between the CQI information and the measurement results in said second measurement unit; and
wherein when performing said switching, the memory information used in generating the CQI information is switched as well.

6. The mobile terminal according to claim 1, further comprising:
a memory unit operable to store a correlation relationship between the measured quality values and the CQI information; and
a compensation unit operable to correct the measurement results in said first measurement unit or the measurement results in said second measurement unit;
wherein said control unit generates said CQI information by obtaining, from said memory unit, the CQI information that corresponds to the measurement results corrected by said compensation unit.

7. A communications device for receiving signals known in advance and signals subjected to adaptive modulation control, comprising:
a first measurement unit operable to measure reception quality of said known signals;
a second measurement unit operable to measure reception quality of said signal that has been subjected to adaptive modulation control;
a control unit operable to control, based on the reception environment, whether to use, primarily, the measurement results in said first measurement unit, or to use, primarily, the measurement results in said second measurement unit, when producing the parameter information that is used in said adaptive modulation control; and
a transmitting part operable to transmit said parameter information to equipment that performs said adaptive modulation.

8. The communications device according to claim 7, wherein:
said control unit is further operable to use, primarily, the measurement results from said second measurement unit when the reception environment is favorable, and to use, primarily, the measurement results from said first measurement unit when the reception environment is not favorable.

9. The communications device according to claim 7, wherein said reception environment is calculated from the measurement results in said first measurement unit.

10. The communications device according to claim 7, wherein:
said control unit is further operable to either:
provide control to switch to generating CQI information using the measurement results in said first measurement unit, or provide control to switch to generating CQI information using the measurement results in said second measurement unit, depending on the reception environment; or
provide control to switch, depending on the reception environment, a weighting ratio for the measurement results in the first measurement unit and the measurement results in the second measurement unit from having the measurement results in the first measurement unit take priority, to having the measurement results in the second measurement unit take priority.

11. The communications device according to claim 10, further comprising:
a memory unit operable to store:
primary memory data including a correlation between the CQI information and the measurement results in said first measurement unit, and
secondary memory data including a correlation between the CQI information and the measurement results in said second measurement unit; and
wherein when performing said switching, the memory information used in rating the CQI information is switched as well.

12. The communications device according to claim 7, further comprising:
a memory unit operable to store a correlation relationship between the measured values and the CQI information; and
a compensation unit operable to correct the measurement results in said first measurement unit or the measurement results in said second measurement unit;
wherein said control unit generates said CQI information by obtaining, from said memory unit, the CQI information that corresponds to the measurement results corrected by said compensation unit.

13. An HSDPA-compatible mobile terminal comprising:
a measurement unit operable to measure HS-PDSCH reception quality; and
a control unit operable to use the measurement results in said measurement unit according to the reception quality when producing said CQI information.

14. The HSDPA-compatible mobile terminal according to claim 13, further operable to measure CPICH reception quality, generate CQI information based on said reception quality by the control unit, and transmit from a transmission unit.

15. A communications device for receiving known signals, and, for transmission equipment that performs adaptive modulation control, transmitting parameter information that is used in said adaptive modulation control, based on a reception quality of said known signal, comprising:
a measurement unit operable to measure reception quality of the signal that was subjected to adaptive modulation control and transmitted from said transmission equipment; and
a control part operable to perform control so that the reception quality measured by said measurement unit is used, depending on the reception environment, when generating said parameter information.

16. The communications device according to claim 15, wherein:
said control unit is further operable to use, primarily, the measurement results from said measurement unit when the reception environment is favorable.

17. The communications device according to claim 15, wherein:
said control unit is further operable to either:
provide control to switch to generating CQI information using the measurement results in said measurement unit, depending on the reception environment; or
provide control to switch, depending on the reception environment, a weighting ratio for the measurement results in the measurement unit to have the measurement results in the measurement unit take priority.

18. The communications device according to claim 17, further comprising:
a memory unit operable to store:
memory data including a correlation between the CQI information and the measurement results in said measurement unit.

19. The communications device according to claim 15, further comprising:
a memory unit operable to store a correlation relationship between the measured values and the CQI information; and
a compensation unit operable to correct the measurement results in said measurement unit;
wherein said control unit generates said CQI information by obtaining, from said memory unit, the CQI information that corresponds to the measurement results corrected by said compensation unit.
